(19) United States
(12) Patent Application Publication
(10) Pub. No.: US 2010/0077325 A1
(43) Pub. Date: Mar. 25, 2010

(54) In Situ Editing of GUI Features

(76) Inventors: Maya Barnea, Kiriat Bialik (IL); Nili Guy, Kiriat Ata (IL); Samuel Kallner, D. N. Menashe (IL); Yoav Rubin, Haifa (IL); Gal Shachor, Yokneam (IL)

Correspondence Address: IBM CORPORATION, T.J. WATSON RESEARCH CENTER, P.O. BOX 218, YORKTOWN HEIGHTS, NY, 10598, US

(21) Appl. No.: 12/236,523

(22) Filed: Sep. 24, 2008

(51) Int. Cl. G06F 3/048

(52) U.S. Cl. 715/763

(57) ABSTRACT

A graphical user interface development system offers a development module that displays GUI elements in an editing window. Respective attribute definition interfaces are provided exclusively within the window that enable in situ editing of attributes of the GUI elements, for example, in-line textual editing and toggling of Boolean attributes. Operator inputs are received via the attribute definition interfaces and attributes of corresponding GUI elements are modified in response to the inputs.

### BACKGROUND

The present invention relates generally to the field of graphical user interface development systems, and specifically to systems and methods for editing attributes of elements within a graphical user interface development environment.

“What You See Is What You Get” (WYSIWYG) is an expression used in computing to describe a system in which content during editing appears very similar to the final product. A WYSIWYG development environment allows a developer to view on screen how, for example, a graphical user interface (GUI) will look when it is displayed in the developed application. One example of a WYSIWYG GUI designer is the Swing GUI Builder for the NetBeans™ interactive development environment, available at the NetBeans web site (netbeans.org). The Swing GUI Builder supports the creation of professional Java® GUIs by placing and aligning components in order to design a GUI form without requiring a developer to understand layout management.

### SUMMARY

An embodiment of the present invention provides a method for developing an interface, which is carried out by presenting a graphical user interface (GUI) development module for development and generation of a GUI that offers in an editing window GUI elements for selection by an operator, the elements having modifiable attributes. A respective attribute definition interface for the GUI elements is provided for the GUI elements exclusively within the window, wherein each of the GUI elements and the respective attribute definition interface are combined into exactly one respective data object. Operator inputs are received via the attribute definition interfaces of a selected GUI element, and in response to the inputs, attributes of the selected GUI element are modified.

In a disclosed embodiment, a method is provided for developing an interface, which is carried out by presenting a graphical user interface (GUI) development module for development and generation of a GUI that offers in an editing window GUI elements for selection by an operator, at least one of the GUI elements having a modifiable Boolean attribute. A respective toggle icon is presented for toggling between values of the Boolean attribute of the at least one of the GUI elements to receive operator inputs directly in the editing window without opening a region separate from the editing window. An operator input is received to actuate the toggle icon of a selected GUI element, and in response to the input, the Boolean attribute of the selected GUI element is modified.

An embodiment of the invention provides a method for developing an interface, including presenting a graphical user interface (GUI) development module for development and generation of a GUI that offers in an editing window GUI elements for selection by an operator, at least one of the GUI elements having a modifiable in-line text attribute. A respective invocation icon is presented for displaying an in-line text editing area for input of the in-line text attribute of the at least one of the GUI elements directly in the editing window without opening a region separate from the editing window. An operator input is received to populate the in-line text attribute of a selected GUI element, and in response to the input, the in-line text attribute of the selected GUI element is modified.

There is further provided, according to an embodiment of the present invention, an apparatus for interface development, including:

a display;

an input device; and

a processor, which is coupled to present a graphical user interface (GUI) development module for development and generation of a GUI that offers in an editing window on the display GUI elements for selection by an operator, the elements having modifiable attributes, to provide a respective definition interface for the GUI elements exclusively within the window, wherein each of the GUI elements and the respective attribute definition interface are combined into exactly one respective data object, to receive operator inputs via the input device to interact with the attribute definition interfaces of a selected GUI element that is presented on the display, and to modify attributes of the selected GUI element responsively to the inputs.

An embodiment of the invention provides a product including a computer-readable medium in which computer program instructions are stored, which instructions, when executed by a computer, cause the computer to present a graphical user interface (GUI) development module for development and generation of a GUI that offers in an editing window GUI elements for selection by an operator, the elements having modifiable attributes, to provide respective attribute definition interfaces for the GUI elements exclusively within the window, wherein each of the GUI elements and their associated attribute definition interfaces are combined into exactly one data object, to receive operator inputs via the attribute definition interfaces of a selected GUI element, and to modify attributes of the selected GUI element in response to the inputs.

### BRIEF DESCRIPTION OF THE SEVERAL VIEWS OF THE DRAWINGS

For a better understanding of the present invention, reference is made to the detailed description of the invention, by way of example, which is to be read in conjunction with the following drawings, wherein like elements are given like reference numerals, and wherein:

FIG. 1 is a block diagram that schematically illustrates a system for editing graphical user interface elements, in accordance with an embodiment of the present invention;

FIG. 2 is a schematic, pictorial illustration of a user interface screen for editing graphical user interface elements, in accordance with an embodiment of the present invention; and

FIG. 3 is a flow chart that schematically illustrates a method for editing graphical user interface elements, in accordance with an embodiment of the present invention.

### DETAILED DESCRIPTION

### Overview

Embodiments of the present invention that are described hereinbelow provide improved methods, products and systems for editing graphic user interface (GUI) elements. In WYSIWYG development environments, for example, it is a primary goal to provide a developer or operator an environment, in the form of an editing window, that looks identical to the final product. In the past, some development environments required the operator to edit modifiable properties of GUI elements by opening a dialog window or attribute editing region external to the editing window.

In embodiments of the invention, a GUI development module provides the operator with an attribute definition interface for editing GUI elements exclusively within the editing window, thereby streamlining the GUI design process. That is to say, the attribute definition interface is available to the user directly in the editing window without opening a region separate from the editing window. The GUI development module typically integrates each GUI element with its attribute definition interface within a single data object, thus providing the ability for the operator to edit the GUI element properties within the editing window. In the context of the present patent application and claims, the GUI development module refers to any software development module that enables the operator to develop and generate a GUI in a WYSIWYG environment, wherein the operator is able to view in an editing window how the GUI will look when displayed to an end user of the GUI. Typically, the GUI development module is one of several development components that comprise an Integrated Development Environment (IDE). Embodiments of the present invention provide the operator with an elegant, fluid editing experience.

### System Description

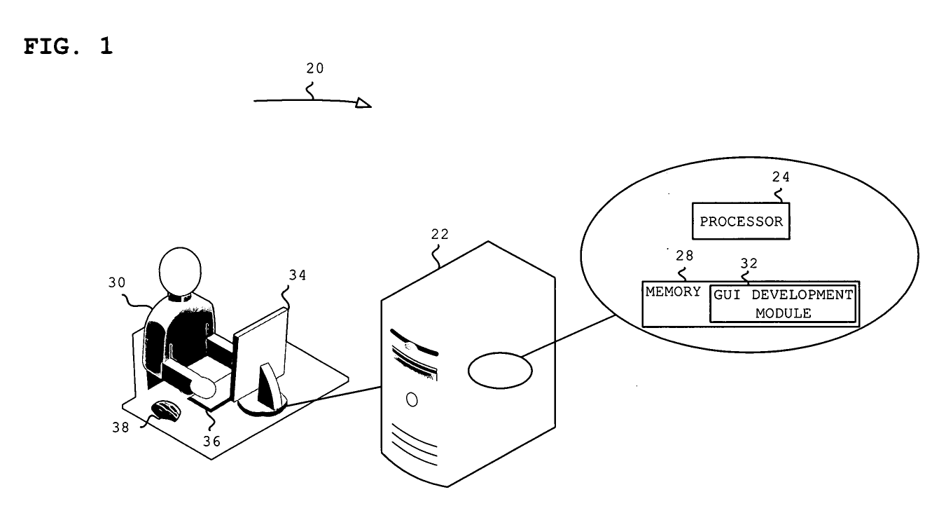

Reference is now made to FIG. 1, which is a block diagram that schematically illustrates a system 20 for editing graphical user interface elements, in accordance with an embodiment of the present invention. System 20 typically comprises a general-purpose computer 22, which is programmed in software to carry out the functions that are described herein. Computer 22 comprises a processor 24 and a memory 28, which holds data structures and information that are used in performing these functions. A GUI development module 32 is held in memory 28. GUI development module 32 may be downloaded to computer 22 in electronic form, over a network, for example, or it may alternatively be provided on tangible media, such as optical, magnetic or electronic memory media. Further alternatively, at least some of the functions of computer 22 may be carried out by dedicated electronic logic circuits. Although this embodiment relates to one particular system for editing GUI elements, the principles of editing that are implemented in system 20 may similarly be applied, mutatis mutandis, in other types of GUI editing systems, using other attribute definition techniques.

System 20 is controlled by an operator 30. Processor 24 operates a display 34. By way of example, operator 30 is assumed to operate computer 22 using a keyboard 36 and/or a pointing device 38, which provide operator inputs to computer 22. It will be understood, however, that operation of embodiments of the present invention is not limited to a particular method for inputting to computer 22, that any other suitable system for providing such operator inputs may be used, and that all such systems are considered to be within the scope of embodiments of the present invention.

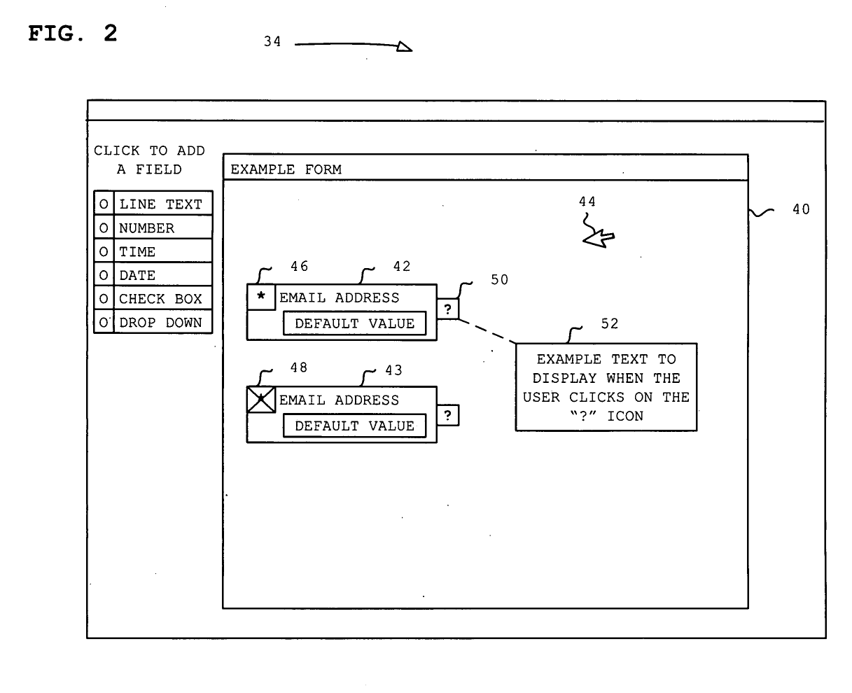

Reference is now made to FIG. 2, which is a schematic, pictorial illustration of a user interface screen for editing graphical user interface elements, in accordance with an embodiment of the present invention. GUI development module 32 (FIG. 1) offers GUI elements 42, 43 for selection by operator 30 in an editing window 40 on display 34. Elements 42, 43 comprise attribute definition interfaces which can be realized for example as a toggle icon 46 or an invocation icon 50, and which are described in detail further below. The attribute definition interfaces may be selected by operator 30 by using a cursor 44 of pointing device 38, although other methods for selection of an attribute definition interface known to those who are skilled in the art may be used. Operator 30 implicitly selects elements 42, 43, when selecting attribution definition interfaces in order to modify their attributes.

Operator 30 (FIG. 1) may select a specific attribute definition interface of one of elements 42, 43 in system 20 by using pointing device 38, e.g., by clicking on the attribute definition interface such as toggle icon 46 or invocation icon 50. Operator 30 may alter modifiable properties of one of elements 42, 43 using the attribute definition interface exclusively within editing window 40, typically by using keyboard 36 to provide inputs to computer 22.

### Embodiment 1

Continuing to refer to FIG. 2, in an embodiment of the present invention, each element together with all of its attribute definition interfaces are incorporated into respective single data objects. The attribute definition interface is exemplified by toggle icon 46. For example, toggle icon 46 and the one of elements 42 comprise a single data object. Toggle icon 46 allows operator 30 to edit and to visualize the definition of an attribute of one of elements 42, 43. Toggle icon 46 may represent a Boolean attribute of one of elements 42, 43. For example, toggle icon 46 may indicate whether the one of elements 42, 43 is a mandatory field (and thus is required be filled out by users of the GUI generated by GUI development module 32) or an optional field. Operator 30 may click on toggle icon 46 using cursor 44 of pointing device 38 to toggle the attribute definition between mandatory and optional settings, rather than being required to open an attribute dialog box or editing region external to editing window 40. By integrating the attribute definition interfaces with elements 42 in the single data object, GUI development module 32 is able to provide access to each attribute definition interface exclusively within editing window 40. Additionally or alternatively, integration of toggle icon 46 and crossed-out toggle icon 48 with elements 42, 43 provides an architectural advantage to GUI development module 32 that simplifies implementation of toggle icon 46.

GUI development module 32 provides a visual indication of the value of the attribute definition, for example showing a crossed-out toggle icon 48 when operator 30 has defined the attribute of one of elements 42, 43 to be optional. In the present example, operator 30 may click on crossed-out toggle icon 48 within editing window 40 to modify the attribute definition of the element to be mandatory. In response, GUI development module 32 displays a modified icon, having the form of toggle icon 46, thereby visually indicating a revised attribute definition, wherein the attribute of one of elements 42, 43 has been defined to be mandatory. A JavaScript listing of a sample attribute definition interface routine that may be used in this context is presented hereinbelow in Listing 1.

Additionally or alternatively, the attribute definition interface is illustrated by invocation icon 50. Invocation icon 50 and a selected one of elements 42 are incorporated in a single data object. Invocation icon 50 enables operator 30 to edit in-line text for display in the GUI generated by GUI development module 32, such as help text associated with one of elements 42, 43. Operator 30 may click on invocation icon 50 using cursor 44 of pointing device 38 to display an in-line text editing area 52. Operator 30 may then proceed to input the in-line text in text editing area 52 within editing window 40 rather than in an attribute dialog box or editing region external to editing window 40, typically by using keyboard 36. Integration of invocation icon 50 with elements 42, 43 provides an architectural advantage to GUI development module 32 that simplifies implementation of invocation icon 50. A JavaScript listing of a sample attribute definition interface routine that may be used in this context is presented hereinbelow in Listing 2.

### In Situ GUI Element Editing

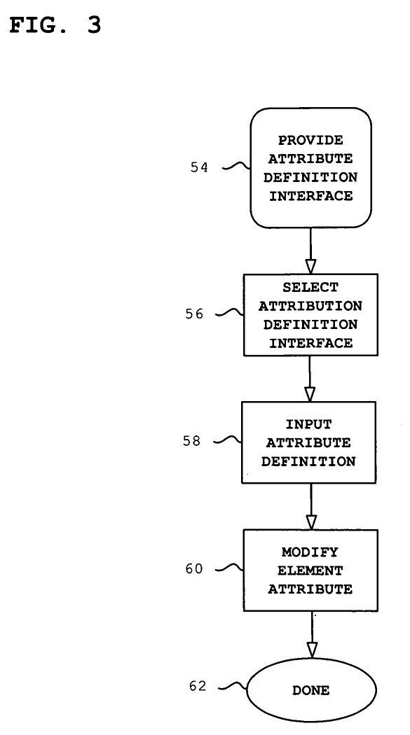

Reference is now made to FIG. 3, which is a flow chart that schematically illustrates a method for editing graphical user interface elements, in accordance with an embodiment of the present invention. Execution of GUI development module 32 (FIG. 1) causes processor 24 to present editing window 40 on display 34 to operator 30 and to perform the steps listed hereinbelow. GUI development module 32 provides operator 30 with various instances of the attribute definition interface for editing elements 42, 43, in an interface presenting step 54.

Operator 30 (FIG. 1) selects the attribute definition interface associated with one of elements 42, 43. Each attribute definition interface may be used by operator 30 to modify the attribute definition of one of elements 42, 43 within editing window 40.

The attribute definition is input by operator 30 to the selected attribute definition interface in an attribute definition inputting step 58 as described above. GUI development module 32 modifies the attribute of one of elements 42, 43 to have the value input by operator 30 in an element attribute modifying step 60. Typically, GUI development module 32 informs operator 30 that the element attribute modification has been made by altering the attribute definition interface displayed in editing window 40. For example, as described hereinabove, operator 30 may modify the attribute of one of elements 42, 43 from having the value of “mandatory” (or “required”) to having the value “optional.” GUI development module 32 causes the attribute definition interface to change from toggle icon 46 to crossed-out toggle icon 48.

The method then terminates at a final step 62.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code stored in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described herein with reference to flow chart illustrations and/or block diagrams of methods, apparatus (systems) and computer program products according to embodiments of the invention. It will be understood that each block of the flow chart illustrations and/or block diagrams, and combinations of blocks in the flow chart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flow charts and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flow charts and/or block diagram block or blocks.

The flow charts and block diagrams in the Figures illustrate the architecture, functionality, and operation of possible implementations of systems, methods and computer program products according to various embodiments of the present invention. In this regard, each block in the flow charts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flow chart illustrations, and combinations of blocks in the block diagrams and/or flow chart illustrations, can be implemented by special purpose hardware-based systems that perform the specified functions or acts, or combinations of special purpose hardware and computer instructions.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

### Computer Program Listings

Listing 1

<img src=“required.gif” id=“reqImg” onclick=“toggleRequired( )”>
<input value=“ui element”>
<script>
function toggleRequired( ) {
var elem = document.getElementById(“reqImg”);
required = !required;
elem.src = required?”required.gif”:”not-required.gif”;
}
</script>

Listing 2

<input value=“ui element”>
<img src=“helpIcon.gif” onclick=“openEditableHelpArea( )”>
<script type=”text/javascript”>
function openEditableHelpArea( )
{
var helpText = prompt(“Enter the help text”,“this is the help”);
/*
The next code line is a call to application specific mechanism
that saves the inputted help text, to the ui_element as the
value for the “help” property
*/
setApplicationProperty(“the_ui_element”,”help”, helpText);
}
</script>

1. A method for developing an interface, comprising:
presenting a graphical user interface (GUI) development module for development and generation of a GUI that offers in an editing window GUI elements for selection by an operator, the elements having modifiable attributes;
providing a respective attribute definition interface for the GUI elements exclusively within the window, wherein each of the GUI elements and the respective attribute definition interface are combined into exactly one respective data object;
receiving operator inputs via the attribute definition interfaces of a selected GUI element; and
responsively to the inputs, modifying attributes of the selected GUI element.

2. The method according to claim 1, wherein the respective attribute definition interface comprises a toggle icon for toggling between values of a Boolean attribute of the GUI elements and visually represents the attribute definition.

3. The method according to claim 2, wherein one of the GUI elements comprises a field to be filled in by a user of the GUI, and wherein the Boolean attribute indicates whether the field is mandatory or optional.

4. The method according to claim 1, wherein the respective attribute definition interface comprises an invocation icon and wherein an in-line text editing area is displayed for input of in-line text for display in the GUI in association with the selected GUI element.

5. The method according to claim 4, wherein the in-line text comprises a help text attribute of the selected GUI element for display in the graphical user interface.

6. The method according to claim 1, wherein the GUI development module comprises a “What You See Is What You Get” (WYSIWYG) GUI development module, and displays in the editing window how the GUI will look when displayed to an end user after generation of the GUI by the WYSIWYG GUI development module.

7. A method for developing an interface, comprising:
presenting a graphical user interface (GUI) development module for development and generation of a GUI that offers in an editing window GUI elements for selection by an operator, at least one of the GUI elements having a modifiable Boolean attribute;
presenting a respective toggle icon for toggling between values of the Boolean attribute of the at least one of the GUI elements to receive operator inputs directly in the editing window without opening a region separate from the editing window;
receiving an operator input to actuate the toggle icon of a selected GUI element; and
responsively to the input, modifying the Boolean attribute of the selected GUI element.

8. A method for developing an interface, comprising:
presenting a graphical user interface (GUI) development module for development and generation of a GUI that offers in an editing window GUI elements for selection by an operator, at least one of the GUI elements having a modifiable in-line text attribute;
presenting a respective invocation icon for displaying an in-line text editing area for input of the in-line text attribute of the at least one of the GUI elements directly in the editing window without opening a region separate from the editing window;
receiving an operator input to populate the in-line text attribute of a selected GUI element; and
responsively to the input, modifying the in-line text attribute of the selected GUI element.

9. Apparatus for interface development, comprising:
a display;
an input device; and
a processor, which is coupled to present a graphical user interface (GUI) development module for development and generation of a GUI that offers in an editing window on the display GUI elements for selection by an operator, the elements having modifiable attributes, to provide a respective definition interface for the GUI elements exclusively within the window, wherein each of the GUI elements and the respective attribute definition interface are combined into exactly one respective data object, to receive operator inputs via the input device to interact with the attribute definition interfaces of a selected GUI element that is presented on the display, and responsively to the inputs, modifying attributes of the selected GUI element.

10. The apparatus according to claim 9, wherein the respective attribute definition interface comprises a toggle icon for toggling between values of a Boolean attribute of the GUI elements and visually represents the attribute definition.

11. The apparatus according to claim 10, wherein one of the GUI elements comprises a field to be filled in by a user of the GUI, and wherein the Boolean attribute indicates whether the field is mandatory or optional.

12. The apparatus according to claim 9, wherein the respective attribute definition interface comprises an invocation icon and wherein the processor is configured to present on the display an in-line text editing area for input of in-line text for display in the GUI in association with the selected GUI element.

13. The apparatus according to claim 12, wherein the in-line text comprises a help text attribute of the selected GUI elements for display in the graphical user interface.

14. The apparatus according to claim 9, wherein the GUI development module comprises a “What You See Is What You Get” (WYSIWYG) GUI development module, and the processor is configured to present on the display in the editing window how the GUI will look when displayed to an end user after generation of the GUI by the WYSIWYG GUI development module.

15. A computer software product, comprising a computer-readable medium in which computer program instructions are stored, which instructions, when executed by a computer, cause the computer to present a graphical user interface (GUI) development module for development and generation of a GUI that offers in an editing window GUI elements for selection by an operator, the elements having modifiable attributes, to provide respective attribute definition interfaces for the GUI elements exclusively within the window, wherein each of the GUI elements and their associated attribute definition interfaces are combined into exactly one data object, to receive operator inputs via the attribute definition interfaces of a selected GUI element, and responsively to the inputs, to modify attributes of the selected GUI element.

16. The product according to claim 15, wherein the respective attribute definition interface comprises a toggle icon for toggling between values of a Boolean attribute of the GUI element and visually represents the attribute definition.

17. The product according to claim 16, wherein the GUI element comprises a field to be filled in by a user of the GUI, and wherein the Boolean attribute indicates whether the field is mandatory or optional.

18. The product according to claim 15, wherein the respective attribute definition interface comprises an invocation icon and wherein the instructions cause the computer to display an in-line text editing area for input of in-line text for display in the GUI in association with the selected GUI element.

19. The product according to claim 18, wherein the in-line text comprises a help text attribute of the selected GUI element for display in the graphical user interface.

20. The product according to claim 15, wherein the GUI development module comprises a “What You See Is What You Get” (WYSIWYG) GUI development module, and wherein the instructions cause the computer to display in the editing window how the GUI will look when displayed to an end user after generation of the GUI by the WYSIWYG GUI development module.
